(19) United States
(12) Patent Application Publication
(10) Pub. No.: US 2025/0252355 A1
(43) Pub. Date: Aug. 7, 2025

(54) ANALOG MATRIX MULTIPLIER FABRIC OPTIMIZATION WITH MACHINE LEARNING

(71) Applicant: Reconceive AI, Inc., San Carlos, CA (US)

(72) Inventors: Jorge A. Grilo, Berkeley, CA (US); Ronald E. Gagnon, JR., Berkeley, CA (US); Charles Prince Buchbinder, San Carlos, CA (US)

(21) Appl. No.: 19/048,823

(22) Filed: Feb. 7, 2025

Related U.S. Application Data
(60) Provisional application No. 63/551,037, filed on Feb. 7, 2024.

(51) Int. Cl. G06N 20/00; G06F 12/02

(52) U.S. Cl. CPC G06N 20/00; G06F 12/023

(57) ABSTRACT

A compute fabric includes, in part, a multitude of compute blocks, a networking circuit adapted to enable communication between the multitude of compute blocks, a performance monitor, and a controller trained to configure the compute fabric. The controller may be trained using a reinforcement learning process by setting the compute fabric to a first state, receiving a measurement of the performance characteristic of the compute fabric from performance monitor, receiving a reward signal in response to the measured performance characteristic; and repeating the setting, the receiving of the measurement and the receiving of the reward signal until the received reward reaches a maximum value. Each of at least a first subset of the compute blocks may be an analog in-memory compute block. Each of at least a second subset of the compute blocks may be a digital compute block.

### RELATED APPLICATION

The present application claims benefit under 35 U.S.C. § 119 of U.S. Provisional Application No. 63/551,037, filed on Feb. 7, 2024, the contents of which is incorporated herein by reference in its entirety.

The present application is related to U.S. application Ser. No. 18/590,823, filed on Feb. 28, 2024, the contents of which is incorporated herein by reference in its entirety.

The present application is also related to, and incorporates by references in its entirety, U.S. application Ser. No. 18/499,124, filed Oct. 31, 2023, which is a continuation of U.S. application Ser. No. 17/104,828, filed Nov. 25, 2020, now U.S. Pat. No. 11,842,167, which is a continuation of application Ser. No. 16/272,901, filed Feb. 11, 2019, now U.S. Pat. No. 11,055,062.

### TECHNICAL FIELD

The present disclosure relates to a compute fabric, and more particularly to compute fabric controlled by a machine learning/artificial intelligence system.

### BACKGROUND

A key part in artificial intelligence and machine learning is the computationally intensive task of matrix multiplication. Matrix multiplication or matrix product is a mathematical operation that produces a matrix from two matrices with entries in a field, or, more generally, in a ring or even a semi-ring. The matrix product is designed for representing the composition of linear maps that are represented by matrices. Matrix multiplication is thus a basic tool of linear algebra, and as such has numerous applications in many areas of mathematics, as well as in applied mathematics, statistics, physics, economics, and engineering. In more detail, if A is an n×m matrix and B is an m×p matrix, their matrix product AB is an n×p matrix, in which the m entries across a row of A are multiplied with the m entries down a column of B and summed to produce an entry of AB. When two linear maps are represented by matrices, then the matrix product represents the composition of the two maps.

Computing matrix products is a central operation in all computational applications of linear algebra. Its computational complexity is O(n³) (for n×n matrices) for the basic algorithm (this complexity is O(n^{2.373}) for the asymptotically fastest known algorithm). This nonlinear complexity means that matrix product is often the critical part of many algorithms. This is enforced by the fact that many operations on matrices, such as matrix inversion, determinant, solving systems of linear equations, have the same complexity. Therefore various algorithms have been devised for computing products of large matrices, taking into account the architecture of computers.

Matrix multiplication is at the heart of all machine learning algorithms and is the most computationally expensive task in these applications. Most machine learning implementations use general-purpose CPUs and perform matrix multiplications in serial fashion. The serial computations in the digital domain together with limited memory bandwidth sets a limit on maximum throughput and power efficiency of the computing system.

### BRIEF DESCRIPTION OF THE DRAWINGS

The following Detailed Description, Figures, and appended Claims signify the nature and advantages of the innovations, embodiments and/or examples of the claimed inventions. All of the Figures signify innovations, embodiments, and/or examples of the claimed inventions for purposes of illustration only and do not limit the scope of the claimed inventions. Such Figures are not necessarily drawn to scale, and are part of the Disclosure.

FIG. 1 is a top level view of a multiplier, in accordance with one embodiment of the present disclosure.

FIG. 2 shows, in part, a configurable compute fabric, in accordance with one embodiment of the present disclosure.

FIG. 3 is an example of a series of instructions used to command and configure the configurable compute fabric of FIG. 2, in accordance with one embodiments of the present disclosure.

FIG. 4 is an example of training and reinforcement learning that may be used to train the compute fabric of FIG. 2, in accordance with one embodiments of the present disclosure.

### DETAILED DESCRIPTION

A configurable matrix multiplier based on switched capacitor, ADC integrated, analog-in-memory compute cells, or otherwise, can be optimized, in accordance with embodiments of the present disclosure, for ideal operation against different performance metrics or modes of operation, i.e. power, latency, throughput, etc.

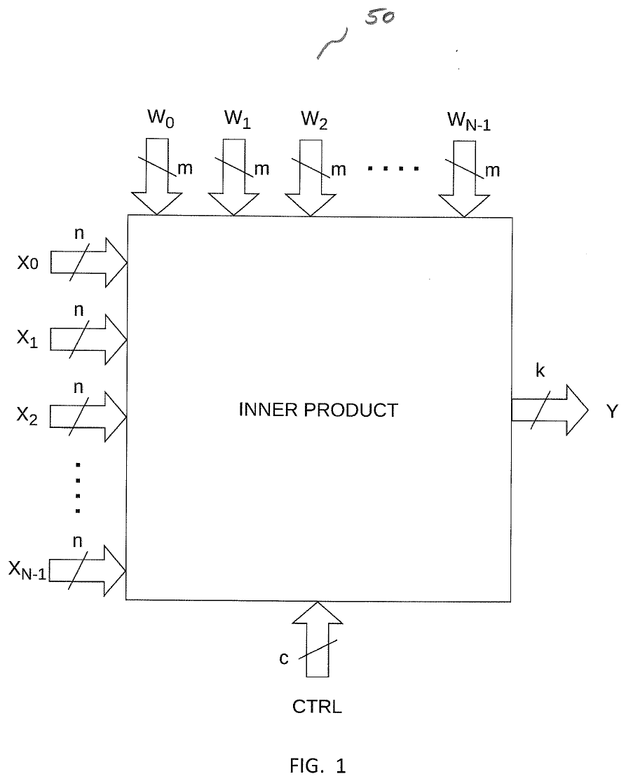

FIG. 1 illustrates a top-level diagram of an exemplary multiplier 50. Multiplier 50 computes N inner products of n-bit inputs (X₀ . . . X_{N-1}) 102 with m-bit weights (W₀ . . . W_{N-1}) 103 in parallel. Multiplier 50 generates one k-bit output (Y) 104.

Performance metrics can be measured using many different techniques. On-chip counters can count system or reference clock cycles to measure latency and through-put which can be timed to the execution of the program, program counters, or other timing and system management signals within the architecture. To measure power, for example, sense resistors can be strategically placed around the chip to measure the current consumed by the design. Voltage can be measured near the point of load using, for example, sense amplifiers, current references, or ADCs. Using each of those measurements alone, or in combination, will provide a measurement of the power and energy by a section of the chip, or multiple sections of the chip, allowing for optimization of the power and energy consumed.

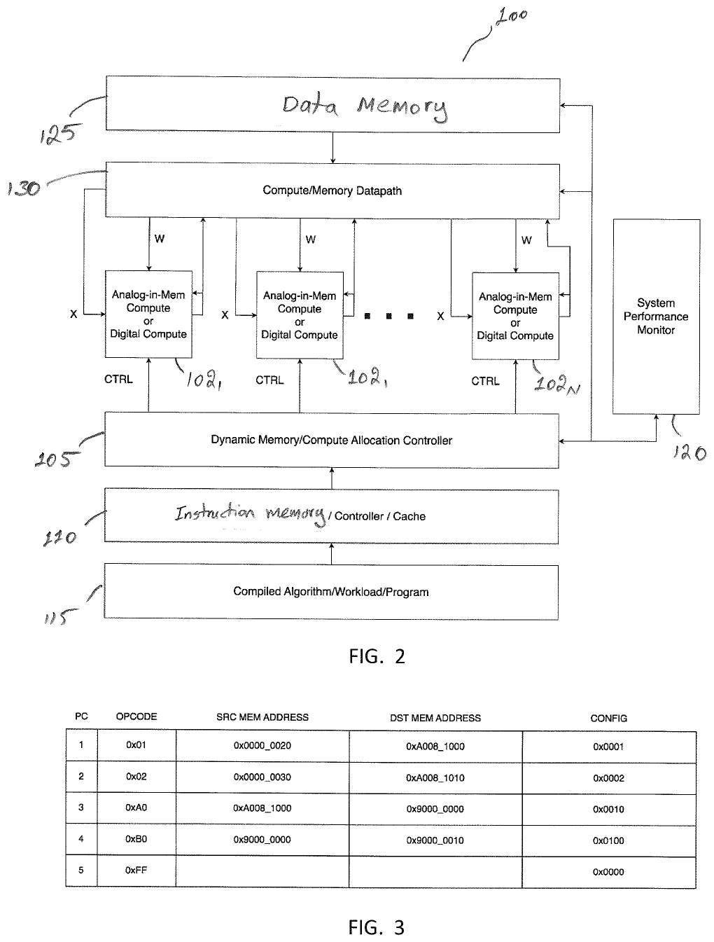

FIG. 2 is a high-level schematic diagram of a compute fabric 100, in accordance with one embodiment of the present disclosure. Compute fabric 100 is shown as including, in part, N analog in-memory compute or digital compute blocks 102ᵢ, namely 102₁, 102₂ . . . 102_{N} each of which corresponds to multiplier 50 shown in FIG. 1; it is understood that i is an index ranging from 1 to N in this example, and N is an integer greater than or equal to 2. The various blocks shown in FIG. 2 may be implemented together on the same die, across dies, or across systems. The control signal (CTRL) for each of the analog in-memory compute or digital compute blocks 102; (alternatively referred to herein as compute block) are connected to a common controller identified in FIG. 2 as dynamic memory/compute allocation controller 105, and alternatively referred to herein as DMCA 105.

The DMCA 105 controls the memory and compute modules through various command and control signals. These control signals include compute block addressing, ADC resolution, W and X bit-depths, computation ordering, or any other signal that provides configurability to the computational accuracy or precision. Compute blocks 102; can be unified into one memory addressing space, allowing for logical mapping of data onto the compute fabric. This also provides the ability to optimize compute ordering so that the compute fabric is fully utilized for computation not just in parallel, but also serially across the compute fabric as partial results are computed and ready for the next stage or layer of computation. The digital compute elements in each digital compute block 102; are shown as being integrated into the compute fabric 100, thereby allowing flexibility in computation ordering, and realizing more advanced mathematical operations or bitwise operations beyond multiply and accumulate.

Compute fabric 100 is also shown as including, in part, a compute/memory data-path block 130, which is a configurable network-on-chip to interface and connect compute blocks 102; together. This can be realized with a variety of network-on-chip protocols and methods. Compute fabric 100 is also shown as including, in part, an external data memory, such as a DRAM, which is connected to DCMA 105 and compute/memory data-path block 130 to provide access to data required by the compiled algorithm/workload/program 115 and loaded into the compute fabric 100, as described further below.

The DMCA 105 is shown as being connected to a system performance monitor 120 that provides feedback to the DMCA 105 of how the system is responding. The system performance monitor 120 measures performance metrics such as throughput, latency, energy consumption or other pertinent performance metrics, as described above System performance monitor 120 can be realized on die or off-chip to provide detailed metrics of performance at the SoC level or system level.

The DMCA 105 controls the flow of data between the compute blocks 102; by configuring the compute/memory data path block 130. The DMCA 105 decodes the instructions received from the instruction memory 110, described below, and causes the compute blocks 102; to execute the instructions. The source and destination address in the instructions, as shown in FIG. 3, inform the DMCA 105 how to command and configure the compute/memory data path block 130.

The control signals the DMCA 105 has command/control over, and provides flexibility and optionality within the compute fabric. Such control signals may be used to configurate status and control registers (not shown) within each block 102ⱼ. For the analog-in-memory compute block, the control signals may be used to configure the bit resolution of the weights W₀ . . . W_{N-} and inputs X₀ . . . X_{N}, the number of inputs to be part of the multiply and accumulation function, the output resolution of the ADC, the reference voltage for the ADC, row configuration and merging, number of computations computed, perhaps some repeated, to increase performance. Wider control signals could include system level parameters, i.e. supply voltage, ambient temperature of the system, and other controls of the system at large.

As shown in FIG. 1, a compiled algorithm/workload/program 115 is loaded and stored in instruction memory/controller/cache 110. The instruction memory/controller/cache 110 is shown as being connected to the DMCA 105. The DMCA 105 is configured to issue instructions and configuration signals to the memory/compute fabric 130 for optimal computation.

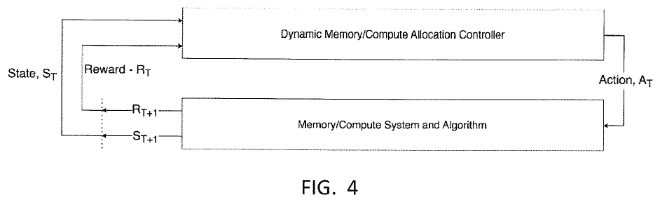

In one embodiment, the DMCA 105 can be a machine learning system, trained on the algorithm and measurable metrics of the compute fabric, such as throughput, latency, energy dissipation. As the machine learning system is trained through reinforcement learning techniques, the machine learning system identifies the best possible configuration of the compute fabric to meet the performance metric that is identified as most important during training as shown and described below with reference to FIG. 4. The training will also determine the optimal allocation of computation resources, memory allocation, and data-path traffic to meet the performance metrics.

As an embodiment of the training of the machine learning system, reinforcement learning techniques can be utilized to optimally determine the configuration to meet performance requirements. Reinforcement learning may use the flow/algorithm shown in FIG. 4. The state variables, S_{T}, are the instructions and control signals, as described with reference to compute fabric 100 of FIG. 2 and the instructions of FIG. 3 that define the state of the system. In other embodiments, the optimization, as well as co-optimization between hardware and software, may include supervised learning, unsupervised learning, evolutionary algorithms, heuristic based algorithms, Monte Carlo analysis, and the like.

Referring to FIG. 4, the reward variables R_{T} is generated from the system performance monitor 120. As the DMCA 105 configures the system during training, the metric, e.g. power, throughput, latency, etc., generated in one example by system performance monitor 120, generates the reward signal so that the DMCA 105 learns how to configure the state variable to maximize the reward variable. The action variables, AT, are the actual signals that configure the compute fabric 100 to maximize the performance metric of interest.

At each iteration of the training step, variable S_{T+1} and R_{T+1} are updated according to the training algorithm driving the optimal action variable AT. The size of the model will be dependent on the size of the computational/memory fabric 100, the width of the data path, and the like The ML algorithm run within the DMCA 105 can be hierarchical to reduce overall complexity and model size. The trained ML algorithms, which may be nested, execute in concert to manage the computational/memory fabric and data path.

The trained model can then be deployed onto the DMCA 105, allowing it to inference the optimal performance of the compute/memory fabric 100 and the algorithm/workload/program 115 being run by the user. As instructions are loaded into the instruction memory 110, the DMCA 105 would infer the configuration based on the computation coded into the instruction. As the DMCA 105 is aware of the entirety of the compute fabric 100, scheduling of resource allocation, memory allocation, and data path congestion is managed per the trained model.

FIG. 3 depicts an example of a compiled algorithm/workload/program 115. The instruction shown contains 4 fields, an opcode, a source memory address, a destination memory address, and a configuration field. The opcode is a binary field, shown in hexadecimal, which signals to the compute fabric which function to execute. The source and destination fields provide DCMA 105 with the address to move data in to and out of the analog-in-memory compute or digital compute blocks 102ᵢ. The configuration field provides the configuration of the compute blocks 102ᵢ that are needed to execute the function identified in the opcode field.

For the compiled program shown in FIG. 3, the analog-in-memory compute block is assumed to have 16 rows and be 8 bits wide. The input data is also 8 bits wide. In the first instruction (PC 1), the instruction is loading data into the memory address which stores the weights for an analog-in-memory compute block, with an opcode of 0x01, and a configuration, indicating 8 bits wide weight data. The second instruction (PC 2) is identical to the first instruction but is loading the input data for the vector-dot-product operation, as depicted by the opcode of 0x02. The third instruction (PC 3) initiates the vector-dot product operation, with opcode 0xA0, for the analog-in-memory compute block addressed at 0xA000_1000. The instruction further tells the system to put the result in address 0x9000_0000. The configuration for this instruction commands that the output be 8 bits in resolution. The fourth instruction (PC 4) is an example of a digital compute function such a scalar multiplication on the data stored in the memory at the source address field, and to put the resultant back in the destination address field. The configuration command is provided to the digital compute block to select the function executed. The fifth instruction (PC 5) indicates program completion, for example.

The instructions shown in FIG. 3 may be optimized by configuration, i.e. bit resolution, as the program is executed, to further improve, for example, the latency without sacrificing the results of the algorithm, as described further below.

Assuming, for example, that optimizing the latency performance is desired. The trained model output can modify the compiled instructions, an example of which is shown in FIG. 3 in the following ways. First, it can optimize the source and destination address to minimize the physical distance traveled. If the system is optimizing latency, this would drive the system to an optimal point by adjusting those memory address to be physically close to one another, thereby minimizing the latency The instructions, an example of which is shown in FIG. 3, can adjust the configuration parameters to optimize the operation. For example, with reference to FIG. 3, the resolution of the data is all configured to have 8 bits. With a multiply and accumulate function output resolution required for full output resolution is given by:

$$y = n + m + log 2 ( N )$$

In the above expression, y represents the output resolution, n and m represent the weight and input resolutions respectively, and N represents the number of weight and input pairs. Therefore, assuming N=1, n=8, and m=8, so the full output resolution is 16, while configured for 8 bit. Under this condition, the trained model will adjust the first two instructions to load just the 4 MSB of the weight and input data, as that is all that would be required to meet the output configuration of 8 bits. The result is an optimization of the latency performance parameter in conjunction with optimizing the addressing.

What is claimed is:

1. A compute fabric comprising:
a plurality of compute blocks;
a networking circuit adapted to enable communication between the plurality of compute blocks;
a performance monitor; and
a controller trained to configure the compute fabric via reinforcement learning comprising:
setting the compute fabric to a first state;
receiving a measurement of the performance characteristic of the compute fabric from performance monitor;
receiving a reward signal in response to the measured performance characteristic; and
repeating the setting, the receiving of the measurement and the receiving of the reward signal until the received reward reaches a maximum value.

2. The compute fabric of claim 1 wherein each of at least a first subset of the plurality of compute blocks is an analog in-memory compute block.

3. The compute fabric of claim 1 wherein each of at least a second subset of the plurality of compute blocks is a digital compute block.
